(19) United States
(12) Patent Application Publication
(10) Pub. No.: US 2005/0102435 A1
(43) Pub. Date: May 12, 2005

(54) Method and device for monitoring an integrated circuit

(76) Inventors: Hui-Hsiang Wu, Kao-Hsiung City (TW); Chao-Lung Tsai, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,299

(22) Filed: Nov. 3, 2004

(30) Foreign Application Priority Data
Nov. 7, 2003 (TW) 092131296

(51) Int. Cl. G06F 3/00

(52) U.S. Cl. 710/1

(57) ABSTRACT

A method for monitoring at least one internal signal of an integrated circuit (IC), which includes a first input/output (I/O) end set and a second I/O end set, includes providing a mode selection mechanism for placing the IC under operation mode or monitor mode, inputting or outputting a data signal set from the first I/O end set and an address signal set from the second I/O end set under the operation mode; and under the monitor mode, inputting or outputting a composite signal set including data and addresses from the first I/O end set, obtaining the addresses of the composite signal set from at least one first end of the first I/O end set, multiplexing the internal signal for output to at least one second end of the second I/O end set, and monitoring signals from the second end to monitor the internal signal.

### BACKGROUND

The invention relates to a method and device for monitoring a circuit, and more particularly, to a method and device for monitoring an integrated circuit (IC).

According to the 8051 standard, information such as data or addresses of an IC is transmitted through a set of input/output ends (also referred to pins). The data and the addresses are alternately arranged and correspond to an ALE signal of the 8051 standard. When the ALE signal is under data transmission mode, the pins transmit the data, and when the ALE signal is under address transmission mode, the pins transmit the addresses. Therefore, an IC complying with 8051 standard cannot transmit the data and the addresses simultaneously.

In addition, in the process of developing an IC, when monitoring internal signals of the IC, it is required to add some additional monitor ends to the IC in order to monitor the internal signals through the monitor ends. Those monitor ends cannot be installed arbitrarily; otherwise their definition according to the IC standard will be changed. Moreover, in order to prevent the package specification of the IC from being changed due to the excessive installation of monitor ends, the internal signals of the IC cannot be monitored freely in mass production process.

As described above, an IC complying with 8051 standard cannot transmit the data and the addresses simultaneously, and the internal signals of the IC cannot be monitored freely in mass production process, which is related to IC quality control. Thus, the prior art retains disadvantages that can be improved.

### SUMMARY

It is therefore a primary objective of the claimed invention to provide a method and device for monitoring an IC to solve the problem mentioned above.

Briefly, a method is provided for monitoring an integrated circuit (IC), to monitor at least one internal signal of the IC. The IC includes a first input/output (I/O) end set and a second I/O end set. The method includes providing a mode selection mechanism for placing the IC under operation mode or monitor mode according to the selection, inputting or outputting a first signal set comprising first information by the first I/O end set and inputting or outputting a second signal set comprising second information by the second I/O end set when the IC is under the operation mode, inputting or outputting a composite signal set comprising the first information and the second information by the first I/O end set when the IC is under the monitor mode, obtaining the information of the composite signal set from at least one first end of the first I/O end set when the IC is under the monitor mode, multiplexing the internal signal to output it to at least one second end of the second I/O end set when the IC is under the monitor mode, and monitoring signals from the second end to monitor the internal signal when the IC is under the monitor mode.

The present invention further provides a monitor device for monitoring at least one internal signal of an IC. The IC includes a first input/output (I/O) end set and a second I/O end set. The device includes at least one multiplexer for multiplexing the internal signal for output to at least one second end of the second I/O end set, wherein the IC can be selectively placed under operation mode or monitor mode. Furthermore, when the IC is under the operation mode, the first I/O end set inputs or outputs a first signal set, and the second I/O end set inputs or outputs a second signal set; and when the IC is under the monitor mode, the first I/O end set inputs or outputs a composite signal set comprising first information of the first signal set and second information of the second signal set.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flowchart of the method for monitoring an IC according to the present invention.

FIG. 2 illustrates a device relating to the method shown in FIG. 1 under operation mode.

FIG. 3 illustrates the device relating to the method shown in FIG. 1 under monitor mode.

FIG. 4 illustrates a related device to the IC shown in FIG. 2 and FIG. 3.

### DETAILED DESCRIPTION

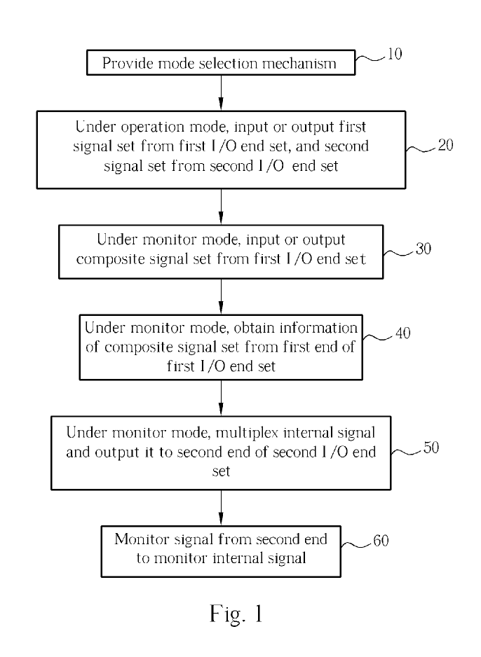

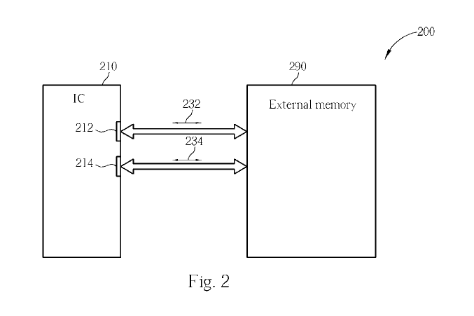

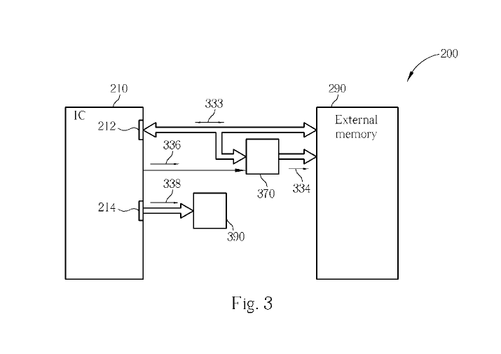

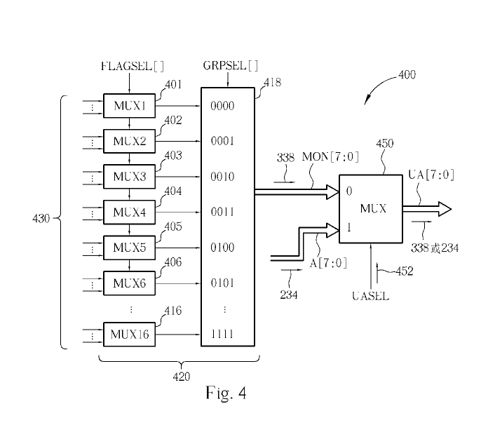

Please refer to FIG. 1 showing a flowchart of the method for monitoring an IC, FIG. 2 showing a device 200 relating to the method shown in FIG. 1 under operation mode, and FIG. 3 showing the device 200 relating to the method shown in FIG. 1 under monitor mode, as well as FIG. 4, which shows a related device 400 to the IC 210 shown in FIG. 2 and FIG. 3. The first embodiment of the present invention provides a method for monitoring at least one internal signal 338 (shown in FIG. 3) of an IC 210 (shown in FIG. 2 and FIG. 3). The IC 210 includes a first I/O end set 212 and a second I/O end set 214. The steps of the method are as follows, and the order of the steps does not limit the present invention.

Step10: Provide a mode selection mechanism (not shown in FIG. 2 and FIG. 3), wherein the IC 210 can be selectively under operation mode (shown in FIG. 2) or monitor mode (shown in FIG. 3) according to the mode selection mechanism.

Step20: Under the operation mode, the IC 210 inputs or outputs a first signal set 232 having first information from the first I/O end set 212, and inputs or outputs a second signal set 234 having second information from the second I/O end set 214.

Step30: Under the monitor mode, the IC 210 inputs or outputs a composite signal set 333 having the first information and the second information.

Step40: Under the monitor mode, obtain the information of the composite signal set 333 from at least one first end (not shown) of the first I/O end set 212 by using at least one sequential circuit 370 which is a “373” logic circuit.

Step50: Under the monitor mode, the IC 210 multiplexes the internal signals 430 with at least one multiplexer 420, which is a plurality of multiplexers 420 shown in FIG. 4, to output the multiplexed internal signals 338 to at least one second end UA[7:0] of the second I/O end sets 214.

Step60: Monitor signals 338 output from the second ends UA[7:0] in order to monitor the internal signals 338.

In this embodiment, the first information represents data, and the second information represents at least one address. The data and the addresses of the composite signal set 333 are alternately arranged in a manner corresponding to an ALE signal of 8051 standard. In Step40, the addresses are obtained from the composite signal set 333 according to the ALE signal 336 so that an external memory 290 can read and write the data according to the addresses, which are transmitted in form of address signals 334 shown in FIG. 3 to the external memory 290.

Please refer to FIG. 1 and FIG. 3 as well as FIG. 4. Step50 is executed by a plurality of multiplexers 420 according to the setup values FLAGSEL[ ] and GRPSEL[ ] of at least one register (not shown), which is a plurality of registers, of the IC 210. By controlling the multiplexing action of the plurality of multiplexers 420 via the setup values FLAGSEL[ ] and GRPSEL[ ] of the registers, the method according to the present invention (Step50) can multiplex eight internal signals 338 from the plurality of internal signals 430 for output, in sequence, from the multiplexer 418 through eight monitor transmission lines MON[7:0] and the multiplexer 450 to eight second ends UA[7:0] of the second I/O end set 214. In addition, required by a specific monitor device 390 (shown in FIG. 3), at least one of the internal signals 338 can be output by analog-to-digital converters (ADC, not shown in FIG. 4), optionally installed on the eight monitor transmission lines MON[7:0], in a digital format to at least one of the second ends UA[7:0]. Therefore, the method according to the present invention (Step50) further includes converting the at least one internal signal 338 into a digital format to output to the at least one second end UA[7:0].

The method according to the present invention (Step10) further includes providing a register, whose setup value is shown as UASEL in FIG. 4, installed in the IC 210. The IC 210 can be selectively placed under operation mode (shown in FIG. 2) or monitor mode (shown in FIG. 3) according to the setup value UASEL of the register with the multiplexer 450 multiplexing the eight internal signals 338 or the eight address signals 234 also according to the setup value UASEL of the register. In other words, when a mode signal 452 shows the setup value UASEL of the register is the setup value of the monitor mode, the multiplexer 450 electrically connects the eight monitor transmission lines MON[7:0] respectively to the eight second ends UA[7:0], and when the mode signal 452 shows the setup value UASEL of the register is the setup value of the operation mode, the multiplexer 450 electrically connects eight address transmission lines A[7:0] respectively to the eight second ends UA[7:0].

The setup value UASEL of the register is optional and does not limit the present invention. The multiplexer 450 can also operate according to a mode signal input to the IC 210. The second embodiment of the present invention is described hereinafter by FIG. 4. The devices and their functions are the same as that of the first embodiment; however, a mode signal 452 according to the second embodiment is a signal input to a mode signal input end UASEL. Therefore in the second embodiment, the method according to the present invention (Step10) further includes providing the mode signal input end UASEL installed in the IC 210 for inputting the mode signal 452. The IC 210 can be selectively placed under operation mode or monitor mode according to the mode signal 452.

Please refer to FIG. 2, FIG. 3, and FIG. 4. In addition to the method, the present invention also provides a monitor device for real-time monitoring of at least one internal signal of the IC 210. The IC 210 includes a first I/O end set 212 and a second I/O end set 214. The device includes at least one multiplexer 420 installed in the IC 210 for multiplexing at least one internal signal 338 for output to at least one second end UA[7:0] of the second I/O end set 214. The IC 210 can be placed under operation mode or monitor mode according to a mode selection mechanism. When the IC 210 is under the operation mode, the first I/O end set 212 inputs or outputs a first signal set 232, and the second I/O end set 214 inputs or outputs a second signal set 234. When the IC 210 is under the monitor mode, the first I/O end set 212 inputs or outputs a composite signal set 333 having first information of the first signal set 232 and second information of the second signal set 234.

In this embodiment, the device further includes at least one sequential circuit 370, which is a latch 370 being a “373” logic circuit in this embodiment, electrically connected to at least one first end (not shown) of the first I/O end set 212 in order to obtain information of the composite signal set 333 from at least one first end.

As described above, the first information represents data, and the second information represents at least one address. The data and the addresses of the composite signal set 333 are alternately arranged to correspond to the ALE signal of the 8051 standard. The sequential circuit 370 obtains the addresses from the composite signal set 333 according to the ALE signal 336 so that an external memory 290 can read and write the data according to the addresses, which are transmitted in form of address signals 334 shown in FIG. 3 to the external memory 290.

The IC 210 further comprises at least one register (not shown), which is a plurality of registers in this embodiment, and at least one multiplexer 420, which is a plurality of multiplexers 420 (shown in FIG. 4) in this embodiment. The multiplexers 420 multiplex eight internal signals 338 according to setup values FLAGSEL[ ], GRPSEL[ ] of two registers—FLAGSEL, GRPSEL, so that the multiplexer 418 may output the eight internal signals 338 to the eight second ends UA[7:0]. By controlling the multiplexing action of the plurality of multiplexers 420 via the setup values FLAGSEL[ ], GRPSEL[ ] of the registers, the device according to the present invention can multiplex the internal signals 338, which are substantially selected from the internal signals 430, and send the multiplexed internal signals 338 to the eight second ends UA[7:0] of the second I/O end set 214 through the eight monitor transmission lines MON[7:0]. In addition, required by a specific monitor device 390 (shown in FIG. 3), the monitor device of the present invention further includes at least one ADC (not shown in FIG. 4), which is optionally installed on the monitor transmission lines MON[7:0], electrically connected to at least one multiplexer 420 and at least one of the second ends UA[7:0] for converting the internal signals 338 into digital format for output to at least one of the second ends UA[7:0]. The ADC installed in the IC 210 is optional but not limiting in the present invention.

As described in the first embodiment, the mode selection mechanism of the monitor device according to the present invention can be a register (not shown in FIG. 4), whose setup value is shown as UASEL in FIG. 4, of the IC 210, and the setup value UASEL of the register corresponds to the operation mode or the monitor mode. Please note that the setup value UASEL of the register is optional and so does not limit the present invention. The multiplexer 450 can operate according to the mode signal 452 input into the IC 210. As described above, the mode selection mechanism of the monitor device can also be a mode signal input end UASEL for inputting a mode signal 452 corresponding to the operation mode or the monitor mode.

In contrast to the prior art, when the IC according to the present invention is under the operation mode, the first I/O end set inputs or outputs the first signal set having the data, and the second I/O end set inputs or outputs the second signal set having the address.

In addition, when the IC according to the present invention is under the monitor mode, the first I/O end set inputs or outputs a composite signal set having the data and the address, and multiplexes at least one internal signal for output to the second I/O end set. Therefore, the quality control of the IC according to the present invention can be easily realized; that is, the internal signals of the IC can be monitored even in a mass production.

Moreover, the IC according to the present invention can be under the operation mode or the monitor mode according to the mode selection mechanism so that additional ends beyond the definition of ends in the 8051 standard can be effectively utilized whether under the operation mode or the monitor mode. The definition of ends does not need to be changed due to the monitoring of the internal signals, and the package specification of the IC does not need to be changed due to the excessive installation of monitor ends.

Those skilled in the art will readily observe that numerous modifications and alterations of the device and method may be made while retaining the teachings of the invention. Accordingly, the above disclosure should be construed as limited only by the metes and bounds of the appended claims.

1. A method for monitoring at least one internal signal of an integrated circuit (IC), the IC comprising a first input/output (I/O) end set and a second I/O end set and the method comprising:
providing a mode selection mechanism for placing the IC under operation mode or monitor mode according to the selection;
when the IC is under the operation mode, inputting or outputting a first signal set comprising first information from the first I/O end set, and inputting or outputting a second signal set comprising second information from the second I/O end set;
when the IC is under the monitor mode, inputting or outputting a composite signal set comprising the first information and the second information from the first I/O end set;
when the IC is under the monitor mode, obtaining the information of the composite signal set from at least one first end of the first I/O end set;
when the IC is under the monitor mode, multiplexing the internal signal to output it to at least one second end of the second I/O end set; and
when the IC is under the monitor mode, monitoring signals from the second end to monitor the internal signal.

2. The method of claim 1 wherein the first step further includes providing a register installed in the IC so that the IC can be selectively placed under the operation mode or the monitor mode according to a setup value of the register.

3. The method of claim 1 wherein the first step further includes providing a mode signal input end installed in the IC for inputting a mode signal so that the IC can be selectively placed under the operation mode or the monitor mode according to the mode signal.

4. The method of claim 1 wherein the first information is data, the second information is an address, and the first information and the second information in the composite signal set are alternately arranged according to an ALE signal complying with 8051 standard with the method obtaining the information according to the ALE signal.

5. The method of claim 1 utilizing at least one sequential circuit to implement the step of obtaining the information.

6. The method of claim 5 wherein the sequential circuit is a latch.

7. The method of claim 1 wherein the first information is data, the second information is an address, and the step that obtains the second information is to have an external memory to be able to read and write the first information according to the obtained second information.

8. A monitor device for monitoring at least one internal signal of an IC, the IC comprising a first input/output (I/O) end set and a second I/O end set and the device comprising:
at least one multiplexer for multiplexing the internal signal for output to at least one second end of the second I/O end set,
wherein the IC can be selectively placed under operation mode or monitor mode, and when the IC is under the operation mode, the first I/O end set inputs or outputs a first signal set, and the second I/O end set inputs or outputs a second signal set; and when the IC is under the monitor mode, the first I/O end set inputs or outputs a composite signal set comprising first information of the first signal set and second information of the second signal set.

9. The device of claim 8 wherein the IC can be selectively placed under the operation mode or the monitor mode according to a mode selection mechanism.

10. The device of claim 9 wherein the mode selection mechanism is a register of the IC, and a setup value of the register corresponds to the operation mode or the monitor mode.

11. The device of claim 9 wherein the mode selection mechanism is a mode signal input end for inputting a mode signal, and the mode signal corresponds to the operation mode or the monitor mode.

12. The device of claim 8 further comprising at least one sequential circuit electrically connected to at least one first end of the first I/O end set for obtaining the information of the composite signal set from the first end when the IC is under the monitor mode.

13. The device of claim 12 wherein the first information is data, the second information is an address, and the first information and the second information in the composite signal set are alternately arranged according to an ALE signal complying with 8051 standard with the sequential circuit obtaining the second information according to the ALE signal.

14. The device of claim 12 wherein the sequential circuit is a latch.

15. The device of claim 12 wherein the first information is data, the second information is an address, and the sequential circuit obtains the second information so that an external memory can read and write the first information according to the obtained second information.

16. The device of claim 8 wherein the IC comprises at least one register, the register multiplexing the internal signal according to its setup value to output the internal signal to the second end.
